(19) United States
(12) Patent Application Publication
(10) Pub. No.: US 2003/0063835 A1
(43) Pub. Date: Apr. 3, 2003

(54) Integrated-optic device and a method for operating on light

(76) Inventors: Ralph Henry Page, Castro Valley, CA (US); Falgun Dineshchandra Patel, Pacifica, CA (US); Tong Xie, San Jose, CA (US); Yakov Sidorin, Mountain View, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 09/970,347

(22) Filed: Oct. 3, 2001

(51) Int. Cl. G02B 6/12; G02B 6/34

(52) U.S. Cl. 385/14; 385/37; 385/40

(57) ABSTRACT

An integrated-optic device comprising a photorefractive substrate, at least one optical waveguide channel formed in the substrate, and at least one diffractive-Bragg grating formed in the substrate. The diffractive-Bragg grating(s) intersects the optical waveguide channel. The diffractive-Bragg grating(s) is configurable to cause at least a fraction of light of at least one wavelength that has been coupled into an input of the optical waveguide channel to be re-directed by the diffractive-Bragg grating(s), thereby preventing the re-directed fraction of light from arriving at the output of the optical waveguide channel.

### TECHNICAL FIELD OF THE INVENTION

The present invention relates to optics and, more particularly, to an integrated-optic device that comprises an optical waveguide channel and at least one diffractive Bragg grating (DBG) integrated with a photorefractive material substrate.

### BACKGROUND OF THE INVENTION

“Free-space optics” is a phrase often used to describe a technology in which three-dimensional (3-D) discrete optical components, such as prisms and lenses, are used to operate on light in a particular manner for a particular purpose. These discrete optical components are often combined in a particular configuration to operate on light in a particular manner to produce a particular optical effect. Due to the 3-D nature of these discrete optical components, light propagates through them over distances of millimeters or centimeters and thus the configuration is referred to as being on a “macroscopic” scale. These discrete optical components are also commonly referred to as “bulk” optical components.

It is known to create optical filters using bulk optical components such as, for example, dielectric filters. The term “optical filter” refers to a device that receives light of multiple wavelengths and that prevents the received light of at least one wavelength from being output from the filter device. In other words, an optical filter is a device that selectively passes or blocks one or more wavelengths of light.

Due to the ever increasing need to provide a capability for performing various types of operations on light, such as filtering, on a “microscopic” scale (i.e., on the order of micrometers), optical integrated circuits (OICs) have been developed that have optical elements that are integrated together in a substrate material to form an OIC. Optical filters have been formed in OICs. OICs are often referred to as “hybrid” OICs because the actual packaged OIC typically includes optical components that are not integrated, but which are included in the packaged system to enable communication with the integrated optical circuit. A fiber-to-waveguide structure is an example of a component often included in the optical IC package for this purpose. Such structures are needed for a variety of reasons such as, for example, to couple integrated optical waveguides to external optical fibers (i.e., to fibers that are external to the optical IC package). In this sense, the optical ICs are viewed as not being fully integrated and are therefore referred to at times as hybrid ICs.

In these types of optical ICs, 3-D integrated optical configurations can be built by combining, or “stacking”, material layers that have two-dimensional (2-D) optical elements integrated optical subsystems. This technique enables 2-D optical elements to be integrated together using large scale, or “batch”, fabrication techniques to form 3-D optical configurations in ICs that operate on light on a microscopic scale. One of the current disadvantages associated with OICs stems from difficulties associated with fabrication and packaging OICs. The stacked layers must be bonded together while taking into account many concerns. For example, corrugated surfaces formed in one or more of the layers (such as relief surface structures) present difficulties in bonding layers together. Packaging of the OIC typically represents a large percentage of the overall costs associated with producing the OIC.

Accordingly, a need exists for a fully-integrated optic device that is capable of operating on light on a microscopic scale and that can be created without having to combine material layers having 2-D optical elements formed therein to obtain 3-D optical configurations. By enabling a fully-integrated optic device to be created without having to combine material layers, the aforementioned difficulties and high costs typically associated with creating and packaging OICs can be avoided.

### SUMMARY OF THE INVENTION

The present invention provides an integrated-optic device comprising a photorefractive substrate, at least one optical waveguide (WG) channel formed in the substrate, and at least one diffractive Bragg grating (DBG) formed in the substrate. The DBG(s) is written into the photorefractive substrate by exposing the substrate to a particular interferometric picture. When light coupled into an input of the optical WG channel propagates through the optical WG channel and impinges on the DBG(s), at least a fraction of light of at least one wavelength is re-directed by the DBG(s), thereby preventing the re-directed light from arriving at an output of the optical WG channel. Thus, the integrated-optic filter device of the present invention filters out at least a fraction of at least one wavelength of light.

When light of multiple wavelengths is coupled into the optical WG channel, and the device comprises a DBG associated with each wavelength of light, one or more of the DBGs may cause fractions of light of the different respective wavelengths to be re-directed, thereby preventing at least fractions of light of different wavelengths from passing to the output of the optical WG channel. One or more wavelengths of light may be completely blocked by the corresponding DBGs and thereby completely prevented from reaching the output of the optical WG channel.

The present invention also provides a method of operating on light coupled into the input of the integrated-optic device. The method comprises the steps of providing an integrated-optic device comprising a photorefractive substrate having at least one optical waveguide channel and at least one diffractive-Bragg grating formed therein, coupling light of at least one wavelength into the optical WG channel such that the light impinges on the DBG, which operates on the light to prevent at least a fraction of the light from arriving at the output of the optical WG channel.

Therefore, in contrast to the known “hybrid” OICs, the present invention provides a fully-integrated optic device that is capable of operating on light on a microscopic scale and that can be created without having to combine material layers having 2-D optical elements formed therein to obtain 3-D optical configurations. By enabling a fully-integrated optic device to be created without having to combine material layers, the difficulties and high costs typically associated with creating and packaging OICs can be avoided.

Furthermore, another advantage of using a photorefractive material for the substrate is that this makes the integrated-optic device re-writable, which means that it is re-programmable. In other words, a holographically-defined DBG that has been written into the photorefractive substrate can be erased from the substrate and a new holographically-defined DBG can be written into the substrate. This feature of the present invention enables the integrated-optic device to be re-programmed so that the manner in which it operates on light, as well as the wavelength(s) of light on which it operates, can be altered. Therefore, the integrated-optic device can be programmed to serve different purposes, which reduces or eliminates the need to replace the device.

These and other features and advantages of the present invention will become apparent from the following description, drawings and claims.

### BRIEF DESCRIPTION OF THE DRAWINGS

FIG. 1 is a perspective view of the integrated-optic device of the present invention, which illustrates a hologram being written into an optical waveguide channel formed in the substrate of the device.

FIG. 2 is a perspective view of the integrated-optic device of the present invention that demonstrates an example embodiment in which light coupled into the optical waveguide channel is filtered for one particular wavelength.

FIG. 3 is a perspective view of the integrated-optic device of the present invention that demonstrates an example embodiment in which light of multiple wavelengths is coupled into the optical waveguide channel and light of at least one wavelength is filtered.

FIG. 4 is a perspective view of the integrated-optic device of the present invention that demonstrates another example embodiment in which light coupled into the optical waveguide channel is filtered for multiple wavelengths of light.

### DETAILED DESCRIPTION OF THE INVENTION

In accordance with the present invention, one or more holographically-defined diffractive Bragg gratings (DBGs) are formed in a photorefractive substrate that has an optical waveguide (WG) channel formed therein. The substrate material preferably is selected to possess properties that enable the DBG(s) to be either electrically, thermally or acoustically modulated. Therefore, each DBG preferably is capable of being dynamically adjusted via electrical, thermal or acoustical modulation of the DBG to enable the manner in which the device operates on light to be dynamically adjusted. However, as discussed below, the integrated-optic device of the present invention can be configured to operate on light in a particular manner without the DBG(s) being modulated at all.

The integrated-optic device of the present invention can be configured such that modulation of a DBG via a DBG modulator renders the modulated DBG operational for a wavelength of light that is phase matched to the period of the DBG. By configuring the integrated-optic device in this fashion, the fraction of light of the wavelength associated with the DBG that is allowed to pass through the DBG to the output of the optical WG channel can be controlled by the manner in which the device is modulated. The modulation feature of the present invention enables a single integrated-optic device that is relatively simple in construction to be configured to operate on light of multiple wavelengths and to be dynamically controllable such that the fractions of light of the different wavelengths that arrive at the output of the optical WG channel are dynamically controllable.

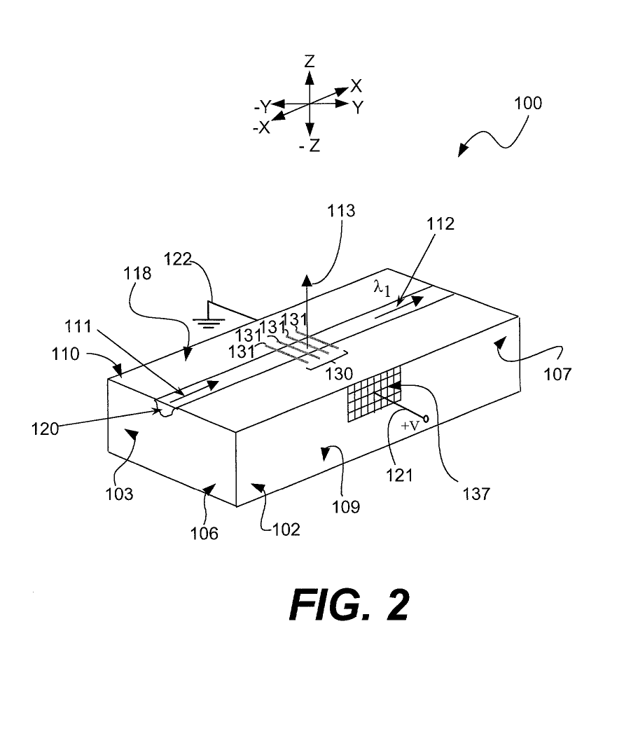

For example purposes, the integrated-optic filter device of the present invention will be described with respect to electrical modulation of the DBG(s), i.e., the DBG(s) will be described as being modulated by an electric field. Therefore, the DBG modulator described in detail herein will be referred to as an electric field modulator. Assuming for example purposes that the DBG(s) are to be modulated with an electric field, the photorefractive substrate material must also possess electro-optic properties, i.e., the substrate material must be a material characterized by non-zero electro-optical coefficients. However, the description provided herein of modulating the DBG(s) via an electric field is being used only for example purposes. As stated above, the substrate material selected could, alternatively, be a material that is capable of being subjected to thermal or acoustical signals to enable the DBG(s) to be thermally or acoustically modulated. The effects that result from modulating the DBG(s) will be described in detail below with reference to FIGS. 2-4.

Another advantage of the present invention is that the integrated-optic filter device is also re-writable, which means that it is re-programmable. This is due to the photorefractive nature of the substrate material in which one or more DBGs are written. In other words, the holographically-defined DBGs can be erased and one or more new holographically-defined DBGs can be written into the substrate material. This feature of the present invention enables the integrated-optic device to be re-programmed so that the manner in which it operates on light, as well as the wavelength(s) of light on which it operates, can be altered.

In accordance with an example embodiment of the present invention, one or more holographically-defined DBGs are formed in a substrate that is photorefractive and that is characterized by non-zero electro-optical coefficients. In accordance with the present invention, it has been determined that the known process of creating volume holograms in bulk photorefractive materials can be used to form a holographically-defined DBG in a substrate material having an optical waveguide (WG) channel integrated in the substrate material to produce an integrated-optic device that is capable of operating as an optical filter to re-direct at least a fraction of one or more wavelengths to prevent the redirected light from arriving at an output of the optical WG channel. The present invention utilizes bulk holographic technology in conjunction with integrated-optics technology to form an integrated-optic filter device.

Bulk, or volume, holograms have been used for various purposes, including, for example, electric-field multiplexing, as described in a publication entitled “Electric Field Multiplexing Of Volume Holograms In Paraelectric Crystals”, by Balberg et al., Applied Optics, Vol. 37, No. 5, Feb. 10, 1998, which is incorporated herein by reference in its entirety. Other publications that discuss various aspects of volume holograms, such as their use in optical switching and storage efficiency, include, respectively, “Free-Space Optical Cross-Connect Switch By Use Of Electroholography”, Applied Optics, Vol. 39, No. 5, Feb. 10, 2000, by Pesach et al., and “Investigation Of The Holographic Storage Capacity Of Paraelectric K₁₋ₓLiₓTa_{1-y}Nb_{y} O₃:Cu, V”, Optics Letters, Vol. 23, No. 8, Apr. 15, 1998, by Pesach et al., which are incorporated herein by reference in their entireties.

The technique used for forming a DBG in a photorefractive bulk material is generally as follows. A beam of high intensity light distribution and a beam of low intensity light distribution are brought together at a certain angle with respect to each other in the plane of the material in which the hologram is to be formed. One of the beams is known as the reference beam and the other is known as the signal beam. The combination of the beams forms an interferometric picture. When the material is exposed in this fashion, the photorefractive material reacts differently to the high and low light intensity distributions to which it is being exposed. In essence, the exposure causes the index of refraction within the material to change depending on the light intensity distribution, which results in refractive index gratings being formed in the material. This change in the optical properties of the material is preserved for some period of time, i.e., the material stores the refractive index gratings.

When the exposure is periodic (e.g., sinusoidal), the variations in the refractive index of the material will also be periodic. These refractive index modulations result in a DBG being formed in the photorefractive material. When the photorefractive material having the refractive index gratings formed therein is exposed to a beam that is phase matched to the gratings, the beam is refracted by the gratings and the volume hologram, which is stored in the material as a spatial distribution of space charge, is reconstructed. This same technique is used to form a holographically-defined DBG in a substrate having an optical WG channel formed therein to produce the integrated-optic device of the present invention.

Filtering light, as that phrase and similar phrases are used herein, is intended to denote re-directing at least a fraction of light of at least one wavelength such that the re-directed light does not reach the output of the optical WG channel. Therefore, light filtering is intended herein to apply to (1) situations in which a fraction of light of one particular wavelength is prevented from reaching the output of the optical WG channel, (2) situations in which all of the light of one particular wavelength is prevented from reaching the output of the optical WG channel, (3) situations in which all of the light of multiple wavelengths is prevented from reaching the output of the optical WG channel, (4) situations in which fractions of light of each of multiple wavelengths are prevented from reaching the output of the optical WG channel, and (5) situations in which fractions of light of one or more, but not all, of multiple wavelengths are prevented from reaching the output of the optical WG channel. The integrated-optic filter device of the present invention is capable of performing any of these light filtering operations, simultaneously or individually, as described in detail below with reference to FIGS. 2-4.

As stated above, the substrate material of the present invention is a photorefractive material. In addition to being photorefractive, in accordance with an embodiment of the present invention, the substrate material is either capable of being electrically modulated, and thus the material has electro-optic properties. The meaning of the term photorefractive generally refers to the ability of the material to locally change its refractive index in response to exposure to light. The term electro-optic is intended to denote a material property that allows the refractive index of the material to change as a result of the application of a direct current (dc) or low-frequency electric field. Materials are known that meet these requirements. For example, one material that is suitable for use as the substrate of the integrated-optic device of the present invention is K₁₋ₓLiₓTa_{1-y}Nb_{y} O₃:Cu, V, which is otherwise referred to in the art as “KLTN”. However, as will be understood by those skilled in the art, in view of the description provided herein, other materials that meet these requirements are also suitable for use as the substrate material.

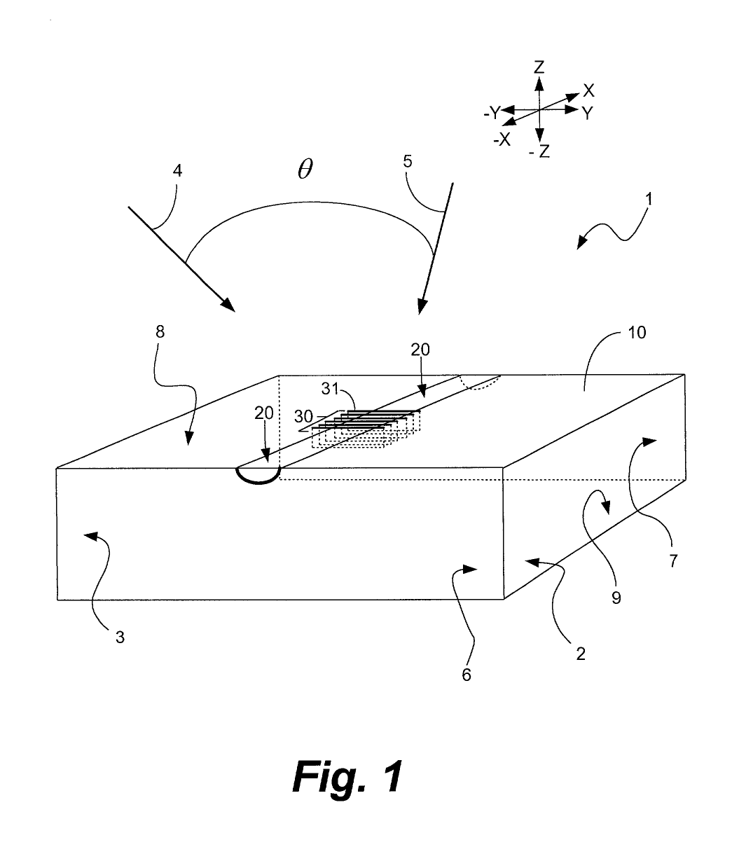

FIG. 1 illustrates a perspective view of the integrated-optic device 1 of the present invention that demonstrates the manner in which the DBG(s) are formed in the substrate of the integrated-optic device 1. FIG. 1 illustrates the storage of information in a substrate 10 in the form of at least one holographically-defined DBG 30. The integrated-optic device 1 of the present invention comprises a substrate 10 having a WG channel 20 formed therein in the direction of the x-axis. FIG. 1 illustrates a single DBG 30 formed in the substrate 10. The DBG 30 intersects the optical WG channel 20. Each of the blocks 31 represents a periodic variation in the refractive index of the substrate material. The combination of these peridically-varying refractive index material layers 31 constitutes a holographically-defined DBG 30.

The blocks 31 are drawn to illustrate the intersecting of the WG channel 20 by the DBG 30. Each block 31 is shown as having a depth in the negative-z direction that is at least as deep as the depth of the WG channel 20 in the negative-z direction (i.e., in the downward direction in FIG. 1). Each block is shown as having a width in the negative-y and positive-y directions that corresponds at least to the width of the WG channel 20 in the negative-y and positively directions. The blocks 31 are spaced apart along the WG channel 20 in the direction of the x-axis, which is coincident with the direction of the WG channel 20. The distance between adjacent blocks 31 in the positive-x direction corresponds to the period of the DBG 30. A waveguide mode within the phase-matching bandwidth of a given DBG will be operated upon by the DBG with an efficiency that depends upon the phase mismatch between the DBG and the waveguide mode. Thus, multiple DBGs formed in the substrate will generally provide an integrated-optic filter device having a multi-wavelength region of operation.

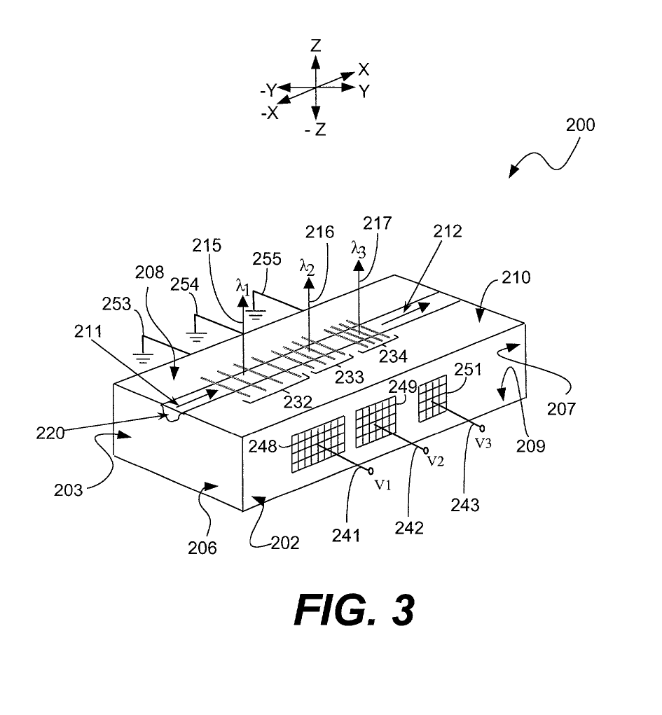

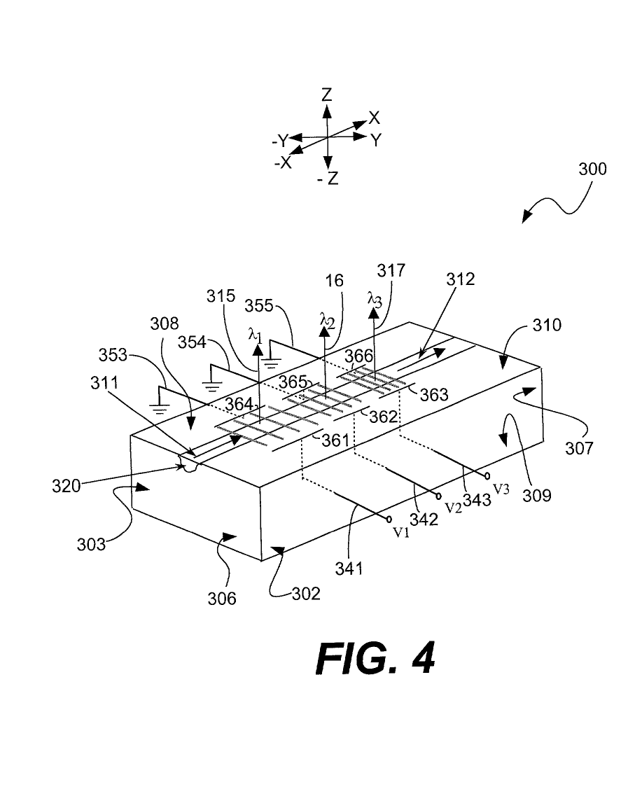

At least one DBG 30 is needed in order to re-direct (i.e., out-couple and/or retro-reflect) at least a fraction of light of at least one wavelength, thereby filtering the light at least to some extent. However, as described below with reference to FIGS. 3 and 4, more than one DBG may be formed in the substrate material to create the integrated-optic filter device 1 of the present invention in order to enable the integrated-optic filter device 1 to be capable of operating on light of multiple wavelengths.

By way of example, the integrated-optic device in accordance with the present invention may be formed by the following method. The optical WG channel is formed in the substrate by using known integrated-optic techniques that include (but are not limited to) ion-exchange, diffusion, etching, sputtering and other methods. Formation of the electrodes is accomplished by using technological methods that are consistent with the desired position and shape of the electrodes. These techniques may range from various metal deposition techniques such as, for example, e-beam evaporation (for electrodes positioned on surfaces of the substrate), to a technique that combines metal deposition techniques with known etching techniques such as, for example, an ion-beam milling or a reactive-ion etching (when electrodes are to be formed in the trenches within the body of the substrate) technique.

FIG. 2 illustrates a perspective view of the integrated-optic device 100 of the present invention in accordance with a first example embodiment in which a single DBG 130 having a period that is phase matched to a particular wavelength of light, λ₁, is formed in the substrate 110. In this example, the integrated-optic equalizer device 100 filters light of wavelength λ₁ that has been coupled into the optical WG channel 120, and this is accomplished without modulating the DBG 130. Only light of wavelength λ₁, which is represented by arrow 111, is operated on by the DBG 130. The arrow 113 represents light of wavelength λ₁ that is re-directed by the DBG 130 in order to reduce the fraction of light of wavelength λ₁ that passes through the DBG 130 to the output of the optical WG channel. The arrow 112 is intended to represent light that is not re-directed by the DBG 130, i.e., light that arrives at the output of the optical WG channel 120. The light that arrives at the output of the optical WG channel 120 could include light of wavelengths that are not phase matched to the period of the DBG 130, as well as a fraction of light of wavelength λ₁ that was not re-directed by the DBG 130. As stated above, the DBG 130 has an efficiency that depends on the efficiency between the waveguide mode and the DBG 130. This efficiency dictates the fraction of light of wavelength λ₁, if any, that will be allowed to pass through the DBG 30 to the output of the optical WG channel 120.

Although FIG. 2 illustrates an example in which light is re-directed by coupling the light out of the plane of the WG channel 120, light could be re-directed by retro-reflection, i.e., reflection in the negative-x direction (opposite to the direction of arrow 111). The many ways in which light may be re-directed when performing filtering will be discussed below in more detail. It should be noted that re-directed light is not necessarily lost or wasted. The re-directed light may be capable of being collected and used for some other purpose, as will be understood by those skilled in the art.

In the example discussed above with reference to FIG. 2, the DBG 130 re-directs light without having to be modulated. As will be described in more detail below with reference to FIGS. 3 and 4, the efficiency of a DBG can be affected by modulating the DBG, which in turn affects the fraction of light of a wavelength that is phase matched to the period of the DBG that is re-directed by the DBG. The description of FIG. 2 provided above is for the purpose of demonstrating the manner in which the integrated-optic device of the present invention can be configured to perform filtering functions without being modulated. However, configuring the integrated-optic device such that the DBG(s) are capable of being modulated is desirable because it allows the fractions of light of one or more wavelengths that are allowed to pass through the optical WG channel to its output to be dynamically varied.

In accordance with the embodiment of FIG. 2, the integrated-optic filter device 100 can be adjusted, or tuned, through modulation by applying an electric field to the DBG 130 to cause the fractions of the wavelengths of light that are out-coupled or retro-reflected by the DBG 130 to be varied. For example, the DBG 130 may be formed in the substrate 110 such that the DBG 130 has an initial “strength”. The “strength” of the DBG 130, as that word is used herein, is intended to denote the ability of the DBG 130 to out-couple or retro-reflect light of a particular wavelength. Thus, the greater the strength of the DBG, the greater the fraction of light that is out-coupled or retro-reflected by the DBG 130 and the smaller the fraction of light that is allowed to pass through the DBG 130 to the output of the optical WG channel 120.

In accordance with this embodiment, an electrode 121 is connected to a grid-like conductive pattern 137 located on the side 102 of the device 100. Likewise, an electrode 122 is connected to a grid-like conductive pattern (not shown) located on the opposite side 103 of the device 100. When a voltage differential is applied over the substrate 110 via application of a voltage signal to electrode, an electric field is generated by the conductive grid-like conductive patterns and is applied to the DBG 130. This electric field causes the strength of the DBG 130 to vary, which causes the fraction of light reaching the output of the optical WG channel 120 to vary. Therefore, in this latter case, the application of the electric field to the DBG 130 causes the refractive indices of the layers 131 of the DBG 130 to vary, which produces a variation in the fraction of light of a wavelength that is phase matched to the period of the DBG 130 that is out-coupled or retro-reflected by the DBG 130. Alternatively, the device 100 could be programmed with a DBG that is only phase matched to light of wavelength λ₁, which is represented by arrow 111, when the DBG is modulated. In this case, when the DBG 30 is not modulated, all light of wavelength λ₁ will pass through the DBG 30 without being re-directed, but when the DBG 30 is modulated, an amount of light of wavelength λ₁ that depends on the degree of modulation of the DBG 130 will be re-directed by the DBG 130.

For example, the integrated-optic filter device 100 shown in FIG. 2 may be configured such that, when no voltage is applied, all of the light 111 of wavelength λ₁ that is coupled into the optical WG channel 120 passes through the DBG 130 to the output of the optical WG channel 120. With this configuration, when a voltage is applied to the DBG 130, the strength of the DBG 130 increases and at least a fraction of the light of wavelength λ₁ that has been coupled into the optical WG channel 120 (arrow 111) is coupled out of the optical WG channel 120 (arrow 113). Thus, the filtering effect of the DBG 130 is dynamically altered by altering the electric field applied to the DBG 130.

Another example of the filtering effect produced by applying the electric field to the DBG 130, or varying the electric field being applied to the DBG 130, would be a device configuration that would not allow any light coupled into the optical WG channel 120 to pass through the DBG 130 when the electric field is not applied. In this example, when the electric field is applied, all of the light of wavelength λ₁ would pass through the DBG 130, but light of all other wavelengths would either be coupled out of the plane of the optical WG channel 120 or retro-reflected in the negative-x direction (opposite the direction of arrow 111). These are merely examples of different manners in which the integrated-optic filter device 100 may be configured so that the absence or presence of an electric field (or other type of modulation), or variations to the electric field already being applied, will provide different filtering effects.

The adjustibility of the integrated-optic filter device 100 via an electric field is possible due to the fact that the material comprising the substrate 110 is an electro-optic material. This means that application of a voltage differential over the material will result in the occurrence of the photoelectric effect, which results in the difference between the refractive indices of the layers 131 of the DBG 130 being either enhanced or reduced. This enhancement or reduction of the differences between these refractive indices causes more or less light, respectively, of the wavelength of light that is phase matched to the period of the DBG 130 to be out-coupled from the WG channel 120 and/or retro-reflected.

The direction of light coupled out of the WG channel 120 by the DBG(s) 130 depends on a variety of parameters and conditions, including (1) the order of the DBG, (2) the distribution of the refractive indices associated with the DBG, with the WG channel and with the substrate, (3) the effective refractive index of the WG mode under consideration, and (4) the wavelength of the light coupled into the optical WG channel. The direction of the fraction of light that is diffracted by the DBG(s) is governed by the equation:

$$sin {θ}_{d} \approx ( \frac{2 M}{p} - 1 ) , \qquad ( Equation 1 )$$

where an integer

$$p = \frac{2 Λ}{λ}$$

defines the DBG order, λ is the effective wavelength of the waveguide mode, Λ is the DBG period and M represents the order of diffraction.

If the order of the DBG is p=1, a fraction of the light coupled into the WG channel having a wavelength that is phase matched to the period of the DBG will be transmitted through the DBG (i.e., in the positive-x direction), and a fraction of the light of that wavelength will be retro-reflected. If the order of the DBG is greater than 1, a fraction of light coupled into the optical WG channel having a wavelength that is phase matched to the period of the DBG will be coupled out of the optical WG channel (i.e., out of the x, y plane) and a fraction of the light of that wavelength will propagate through the DBG to the output of the WG channel (i.e., in the positive-x direction). In this latter case, a fraction of the light coupled into the optical WG channel having a wavelength that is phase matched to the period of the DBG will also typically be retro-reflected.

Therefore, the device of the present invention can function as a filter device as long as the DBG integrated in the substrate has an order that is equal to or greater than 1. This is because, for a DBG of any of these orders, the fraction of light that is allowed to pass through the optical WG channel to its output is controllable either through out-coupling or retro-reflection, or both. The direction of out-coupling of light (i.e., coupling out of the x, y plane) is generally independent of whether or not a voltage is applied to the device. As stated above, applying an electric field to the DBG affects the size of the fraction of light of a wavelength that is phase matched to the period of the DBG that is out-coupled and/or retro-reflected.

FIG. 3 is a perspective view of an integrated-optic filter device 200 of the present invention that illustrates the integrated-optic filter device 200 configured to operate on multiple wavelengths of light. In this example, the device 200 has multiple channels, each of which corresponds to a respective wavelength of light, λ₁, λ₂, and λ₃. For example purposes, the device 200 is shown as having three different DBGs 232, 233 and 234 formed therein. The first DBG 232 has a period that is phase matched to light of wavelength λ₁. The second DBG 233 has a period that is phase matched to light of wavelength λ₂. The third DBG 234 has a period that is phase matched to light of wavelength λ₃.

In the example embodiment shown in FIG. 3, the device 200 is configured so that a voltage signal can be individually applied to each of the DBGs 232, 233 and 234 via electrodes 241, 242 and 243, respectively, to cause the DBGs 232, 233 and 234 to be individually modulated. On side 202 of the device 200, each of the conductive grid-like patterns 248, 249 and 251 (and the respective conductive grid-like patterns on side 203) represents conductive elements that set up electric fields in the material of the substrate 210 when a voltage is applied to the corresponding terminal 241, 242 or 243. Application of the electric field causes the refractive indices of the material layers of the corresponding DBG to be dynamically varied, thereby causing the manner in which the corresponding DBG operates on light to be dynamically varied.

For example purposes, it will be assumed that when no electric field is applied to a DBG, the DBG will pass all wavelengths of light coupled into the optical WG channel 220. It will also be assumed that when an electric field is applied to any DBG, that DBG will re-direct light at least a fraction of light of a wavelength that is phase matched to the period of the modulated DBG. Thus, when a voltage is applied to terminal 241, at least a fraction of light of wavelengths λ₁ will be re-directed by DBG 232, but light of wavelengths λ₂ and λ₃ will pass through the optical WG channel 220 to the output of the optical WG channel 220. Similarly, when a voltage is applied to terminal 242, light of wavelengths λ₁ and λ₃ will pass through the optical WG channel 220 to the output of the optical WG channel 220, but at least a fraction of light of wavelength λ₂ will be re-directed by DBG 233, thereby preventing it from arriving at the output of the optical WG channel 220. When a voltage is applied to terminal 243, light of wavelengths λ₁ and λ₂ will pass through the optical WG channel 220 to the output of the optical WG channel 220, but at least a fraction of light of wavelength λ₃ will be re-directed by DBG 234, thereby preventing it from arriving at the output of the optical WG channel 220.

The light that passes through the optical WG channel 220 to the output of the optical WG channel 220 is represented by arrow 212. The light that is re-directed by DBGs 232, 233 and 234 is represented by arrows 215, 216 and 217, respectively. Although arrows 215, 216 and 217 illustrate light coupled out of the plane of the optical WG channel 220, this is merely for illustrative purposes. The re-directed light may be out-coupled and/or retro-reflected depending on the orders of the DBGs and other factors, as discussed above in detail. It should be noted that, because each DBG 232, 233 and 234 can be individually modulated, the types of filtering operations that are capable of being performed by the present invention is virtually unlimited in number. The extent to which any single DBG or combination of DBGs is modulated will alter the fractions of light of one or more wavelengths that are re-directed by the DBG(s). Therefore, with respect to the wavelength(s) of light the device 200 is configured to operate on, virtually any desired filtering effect can be obtained by modulating the DBG(s) in a particular fashion.

Also, although the embodiments discussed above with reference to FIGS. 2 and 3 illustrate the use of electrodes and respective conductive grid-like patterns specifically located and shaped to modulate the DBGs with an electric field, this is only for example purposes. It should be noted that the present invention is not limited with respect to the location, shape or size of the conductive elements used to produce the electric fields or with respect to the techniques used to create the conductive elements. The conductive elements may be, for example, placed on surfaces 208 and 209 of the substrate 210 or on surfaces 206 and 207 of the substrate 210. Alternatively, the conductive elements may be immediately adjacent to, or in contact with, the regions within the substrate material in which the DBGs are formed, as shown in FIG. 4. FIG. 4 illustrates conductive elements 361, 363 and 363 that are connected to terminals 341, 342 and 343, respectively, and conductive elements 364, 365 and 366 that are connected to ground terminals 353, 354 and 355, respectively. The conductive elements 361-366 are in contact with the portions of the substrate material in which the DBGs are comprised. FIG. 4 is merely a pictorial representation of this form of connection and is not intended to schematically illustrate the manner in which such conductive elements might actually be configured. The conductive elements 361-366 may be, for example, conductive trace patterns formed in the substrate 310 in a particular manner.

Preferably, the material comprising the substrates 110, 210 and 310 shown in FIGS. 2, 3 and 4, respectively, allows information that is holographically stored in the substrate to be erased and new information to be written into the substrate. The DBG(s) originally formed in the substrate will be preserved for at least some period of time, i.e., the substrate stores the DBG(s) for some period of time. The DBG(s) can be erased by, for example, uniformly exposing the substrate to light at a particular wavelength (e.g., ultraviolet light) and/or by subjecting the substrate to elevated temperatures. Materials are known that are capable of preserving a DBG for some period of time, or until the DBG is erased, and that are capable of being re-written with a new DBG.

Although it is not a requirement of the present invention that the material used for the substrate be capable of being re-written, it is beneficial to use a material that is capable of being re-written, because doing so enables the integrated-optic filter device to be programmed and re-programmed to be effective for different wavelengths of light. However, even an integrated-optic filter device that cannot be re-programmed by re-writing a new DBG(s) to it is useful for the wavelength or bandwidth of light for which it was originally created. The re-writability of the substrate adds further advantages to the present invention by providing the integrated-optic device with greater versatility and flexibility.

The present invention has been described with reference to certain preferred and example embodiments. The present invention is not limited to the embodiments described above, as will be understood by those skilled in the art from the discussion provided herein. The manner in which the integrated-optic device of the present invention functions depends on a large number of parameters, including the material used as the substrate, the wavelength(s) of light upon which the device operates, the number and order of grating(s) comprised in the device, the manner in which the grating(s) are formed in the substrate (e.g., the type of exposure used to create the grating(s)), the refractive indices involved, the manner in which the DBGs are modulated, etc. Those skilled in the art will understand the manner in which these and other parameters can be selected to create the desired light filtering effect.

What is claimed is:

1. An integrated-optic device comprising:
a photorefractive substrate;
at least one optical waveguide channel formed in the substrate, said at least one optical waveguide having an input and an output; and
at least one diffractive-Bragg grating formed in said substrate, said at least one diffractive-Bragg grating intersecting said optical waveguide channel, wherein when light is coupled into said optical waveguide channel, at least a fraction of the light coupled into said optical waveguide channel is re-directed by said at least one diffractive-Bragg grating, thereby preventing the re-directed fraction of light from arriving at the output of the optical waveguide channel.

2. The integrated-optic device of claim 1, wherein said at least one diffractive-Bragg grating is modulated in particular manner to control the fraction of light that is re-directed.

3. The integrated-optic device of claim 2, wherein said at least one diffractive-Bragg grating is electrically modulated.

4. The integrated-optic device of claim 2, wherein said at least one diffractive-Bragg grating is thermally modulated.

5. The integrated-optic device of claim 2, wherein said at least one diffractive-Bragg grating is acoustically modulated.

6. The integrated-optic device of claim 1, further comprising:
a diffractive-Bragg grating modulator, the diffractive-Bragg grating modulator being capable of modulating said at least one diffractive-Bragg grating, wherein when said at least one diffractive-Bragg grating is modulated, the fraction of light that is re-directed by the diffractive-Bragg grating is varied.

7. The integrated-optic device of claim 6, wherein the diffractive-Bragg grating modulator is an electric field generator, the electric field generator being capable of generating an electric field that electrically modulates said at least one diffractive-Bragg grating to thereby vary the fraction of light that is re-directed by the diffractive-Bragg grating.

8. The integrated-optic device of claim 6, wherein the diffractive-Bragg grating modulator is an acoustical modulator, the acoustical modulator being capable of acoustically modulating said at least one diffractive-Bragg grating to thereby vary the fraction of light that is re-directed by the diffractive-Bragg grating.

9. The integrated-optic device of claim 6, wherein the diffractive-Bragg grating modulator is a thermal modulator, the thermal modulator being capable of thermally modulating said at least one diffractive-Bragg grating to thereby vary the fraction of light that is re-directed by the diffractive-Bragg grating.

10. The integrated-optic device of claim 1, wherein said at least one diffractive-Bragg grating has a period associated with it and wherein the light coupled into the optical waveguide channel is of one or more wavelengths, and wherein said fraction of re-directed light is light of a wavelength that is phase matched to the period of said at least one diffractive-Bragg grating.

11. The integrated-optic device of claim 6, the integrated-optic device being configured to operate as an integrated-optic filter device, wherein at least first and second diffractive-Bragg gratings are formed in said substrate, each of said gratings intersecting said optical waveguide channel, the first diffractive-Bragg grating having a first wavelength λ₁ of light associated therewith, the second diffractive-Bragg grating having a second wavelength λ₂ of light associated therewith, wherein when the first diffractive-Bragg grating is not modulated, the first diffractive-Bragg grating is transmissive to at least a fraction of light of wavelength λ₁, and wherein when the first diffractive-Bragg grating is modulated, at least a fraction of light of wavelength λ₁ is re-directed by the first diffractive-Bragg grating, and wherein when the second diffractive-Bragg grating is not modulated, the second diffractive-Bragg grating is transmissive to at least a fraction of light of wavelength λ₁, and wherein when the second diffractive-Bragg grating modulated, at least a fraction of light of wavelength λ₂ is re-directed by the second diffractive-Bragg grating.

12. The integrated-optic filter of claim 1, wherein at least a fraction of the light that is re-directed is coupled out of the optical waveguide channel.

13. The integrated-optic device of claim 1, wherein at least a fraction of the light that is re-directed is retro-reflected by said at least one diffractive-Bragg grating in a direction opposite to a direction at which the light was coupled into the optical waveguide channel.

14. The integrated-optic filter device of claim 11, wherein substantially all light of wavelengths λ₁ is re-directed by said first diffractive-Bragg grating when said first diffractive-Bragg grating is modulated.

15. The integrated-optic filter device of claim 11, wherein substantially all light of wavelengths λ₂ is re-directed by said first diffractive-Bragg grating when said second diffractive-Bragg grating is modulated.

16. The integrated-optic device of claim 1, wherein the device can be re-programmed by erasing said at least one diffractive-Bragg grating formed in said substrate and by forming at least one other diffractive-Bragg grating in said substrate by exposing said substrate to a particular interferometric picture.

17. A method of operating on light input to an integrated-optic device, the method comprising the steps of:
providing an integrated-optic device comprising a photorefractive substrate, the integrated-optic device having an optical waveguide channel and at least one diffractive-Bragg grating formed in said substrate; and
coupling light into an input of the optical waveguide channel such that the light propagates through the optical waveguide channel and impinges on said at least one diffractive-Bragg grating and is operated on by said at least one diffractive-Bragg grating to cause at least a fraction of the light to be re-directed to prevent the re-directed fraction of light from arriving at an output of the optical waveguide channel.

18. The method of claim 17, wherein the substrate possesses electro-optic properties, the method further comprising the step of:
subjecting said at least one diffractive-Bragg grating to an electric field, wherein when said at least one diffractive-Bragg grating is subjected to said electric field, the fraction of light that is re-directed by said at least one diffractive-Bragg grating is varied.

19. The method of claim 17, further comprising the step of:
acoustically modulating said at least one diffractive-Bragg grating, wherein when said at least one diffractive-Bragg grating is acoustically modulated, the fraction of light that is re-directed by said at least one diffractive-Bragg grating is varied.

20. The method of claim 17, further comprising the step of:
thermally modulating said at least one diffractive-Bragg grating, wherein when said at least one diffractive-Bragg grating is thermally modulated, the fraction of light that is re-directed by said at least one diffractive-Bragg grating is varied.

21. The method of claim 17, wherein at least first and second diffractive-Bragg gratings are formed in said substrate, the first diffractive-Bragg grating having a first wavelength λ₁ of light associated therewith, the second diffractive-Bragg grating having a second wavelength λ₂ of light associated therewith, the method further comprising the step of:
providing a diffractive-Bragg grating modulator capable of modulating said first and second diffractive-Bragg gratings; and
modulating at least one of said first and second diffractive-Bragg gratings, wherein when the first diffractive-Bragg grating is not modulated, the first diffractive-Bragg grating is transmissive to at least a fraction of light of wavelength λ₁, and wherein when the first diffractive-Bragg grating is modulated, at least a fraction of light of wavelength λ₁ re-directed by the first diffractive-Bragg grating, and wherein when the second diffractive-Bragg grating is not modulated, the second diffractive-Bragg grating is transmissive to at least a fraction of light of wavelength λ₂, and wherein when the second diffractive-Bragg grating modulated, at least a fraction of light of wavelength λ₂ is re-directed by the second diffractive-Bragg grating.

22. The method of claim 17, wherein the integrated-optic device can be re programmed to operate on light in a different manner by performing the steps of:
erasing said at least one diffractive-Bragg grating formed in said substrate; and
forming at least one other diffractive-Bragg grating in said substrate by exposing said substrate to a particular interferometric picture.
